(19) United States
(12) Patent Application Publication
(10) Pub. No.: US 2017/0249872 A1
(43) Pub. Date: Aug. 31, 2017

(54) SURGICAL TRAINING PHANTOM WITH SPECTROSCOPICALLY DISTINCT REGIONS

(71) Applicants: Cameron PIRON, Toronto (CA); Murugathas YUWARAJ, Markham (CA); Fergal KERINS, Toronto (CA)

(72) Inventors: Cameron PIRON, Toronto (CA); Murugathas YUWARAJ, Markham (CA); Fergal KERINS, Toronto (CA)

(21) Appl. No.: 15/516,865

(22) PCT Filed: Nov. 10, 2014
(86) PCT No.: PCT/CA2014/051080

§ 371 Date: Apr. 4, 2017

(51) Int. Cl. G09B 23/34; B29C 45/14; G09B 23/28; B29C 39/12

(52) U.S. Cl. CPC G09B 23/34; B29C 39/12; B29C 45/1418; G09B 23/286; B29L 2031/40

(57) ABSTRACT

The present disclosure discloses anatomical phantoms having one or more distinct regions spectroscopically differentiated from each other by inclusion of spectroscopically active components each having a distinct fluorescence/emission/scattering spectrum. The distinct regions may represent different anatomical components of the corresponding real anatomical part and/or tumor mimics (or other diseased tissue) and different anatomical components of the corresponding real anatomical part, or just tumor mimics and a remainder of the anatomical part. The spectroscopically active materials may be dyes such as the cyanine dyes, or spectroscopically active nanoparticles.

### FIELD

The present disclosure relates to anatomical phantoms having anatomical components with different spectroscopic signatures.

### BACKGROUND

Surgical training phantoms are very useful for providing a practice forum for surgeons who are starting surgery and require a controlled practice environment in which they can practice on generic anatomical phantoms, or surgeons needing to practice for a complicated surgery on an actual patient. For these applications the most useful phantoms are constructed to provide realistic biomechanical properties of actual tissue regions being operated or passed through during the medical procedure. Such a phantom must therefore approximate as close as possible actual tissue being encountered in the procedure, for example, healthy tissue is generally biomechanically different from tumor tissue, when the procedure is tumor resection. Also, in the example of the brain, various sub-anatomical structures within the organ can differ in firmness and their locations and distances from a surgical target can be used to plan the best trajectory to a chosen target. Thus a realistic phantom would contain tissue mimic materials for each type of tissue likely to be encountered during the medical procedure. The different types of tissue/tumor may be characterized by different tissue density, location and orientation. For example tumors are not usually characterized by oriented tissue (as are muscle tissue, ligaments, tendons etc.) and are typically of different density compared to healthy tissue.

While having phantom with life-like biomechanical properties, it is known that different tissues exhibit different spectroscopic properties. It would be desirable to produce a phantom in which the various constituent parts are produced having different spectroscopic signatures which may then be used by a operator for refining their surgical skills.

### SUMMARY

The present disclosure discloses anatomical phantoms having distinct regions spectroscopically differentiated from each other by inclusion of spectroscopically active materials each having a distinct spectrum. The distinct regions may represent different anatomical components of the corresponding real anatomical part and/or tumor mimics and different anatomical components of the corresponding real anatomical part, or just tumor mimics and a remainder of the anatomical part. The spectroscopically active materials may be dyes such as, fluorophores or spectroscopically active nanoparticles.

A further understanding of the functional and advantageous aspects of the present disclosure can be realized by reference to the following detailed description and drawings.

### BRIEF DESCRIPTION OF THE DRAWINGS

Embodiments disclosed herein will be more fully understood from the following detailed description thereof taken in connection with the accompanying drawings, which form a part of this application, and in which:

FIG. 1 is an illustration of an example port-based surgical approach. A port is inserted along the sulci to approach a tumor located deep in the brain.

FIG. 2 is an illustration of an example training model in an exploded view, illustrating parts of the base component and the training component.

FIG. 3 is an illustration of an example base component of the training model illustrating the tray, the head and the skull.

FIG. 4 is an illustration of an example base component of the training model without the skull section, illustrating fiducials that are important for registration of images acquired using different modalities.

FIG. 5 is an illustration of an example base component of the training model, shown containing the training component.

FIG. 6 is a diagram showing training phantom of an anatomical part, for example a brain, and a surgical port used to access the portion of the brain for practice purposes.

FIG. 7 shows the molecular structures of several Cyanine (Cy) dyes R=SO3⁻ for aqueous solubility; R=H (or alkyl) for solubility in organic solvents.

FIG. 8 shows the molecular structures of several Quasar Dyes^{R}.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions.

As used herein, the term “patient” is not limited to human patients and may mean any organism to be treated using the planning and navigation system disclosed herein.

As used herein, “hydrogels” refer to materials that are formed by crosslinking polymer chains, through physical, ionic or covalent interactions and are known for their ability to absorb water. An example of a physical interaction that can give rise to a hydrogel is by thermal treatment of the liquid hydrogel precursor which, prior to being subjected to a freeze thaw cycle is a liquid or near liquid. The process of freezing the liquid precursor acts to freeze the water contained in the polymer/water mixture and ice particles causes the polymer strands to be topologically restricted in molecular motion by other chains thus giving rise to the “entanglement” cross linking to produce the hydrogel. Hydrogels that have been produced by a freeze that cycle are sometimes referred to as “cryogels”.

Hydrogels characterized by cross linking that are produced through ionic or covalent interactions typically require a cross linking (XL) agent and/or an initiator and activation by methods such as heat or radiation.

As used herein, the phrase “spectroscopically active materials” refers to materials that have known and distinct detectable spectral characteristics such as, but not limited to, absorption, scattering, fluorescence, phosphorescence, Raman scattering, linear birefringence, circular birefringence, linear dichroism, circular dichroism, etc. When these materials, whether molecular in origin such as fluorophores, solid nanoparticles such as semiconductor nanoparticles and the like are illuminated by light of appropriate wavelengths they respond at one or more known wavelengths which are readily detectable either by light emission (such as but not limited to direct emission, fluorescence) scattering etc.

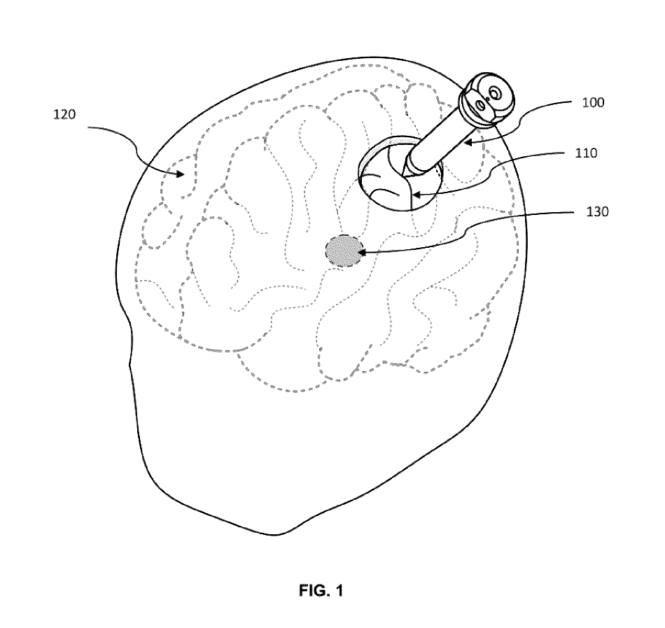

When performing surgical and/or diagnostic procedures that involve the brain, neurosurgical techniques such as a craniotomy, or a minimally invasive procedure such as an endo-nasal surgery or a port based surgical method, may be performed to provide access to the brain. In such procedures, as indicated, the medical procedure is invasive of the mammalian head. For example, in the port-based surgical method illustrated in FIG. 1, a generally cylindrical port (100) is inserted along the sulci (110) of the brain (120) to access a tumor (130) located deep in the brain. The cylindrical port (100) provides the surgeon with access to the interior portion of the patient's brain being operated on.

According to embodiments provided herein, the simulation of such procedures may be achieved by providing a brain model that is suitable for simulating the surgical procedure through one or more layers of the head. Such a procedure may involve perforating, drilling, boring, punching, piercing, or any other suitable methods, as necessary for an endo-nasal, port-based, or traditional craniotomy approach. For example, some embodiments of the present disclosure provide brain models comprising an artificial skull layer that is suitable for simulating the process of penetrating a mammalian skull. As described in further detail below, once the skull layer is penetrated, the medical procedure to be simulated using the training model may include further steps in the diagnosis and/or treatment of various medical conditions. Such conditions may involve normally occurring structures, aberrant or anomalous structures, and/or anatomical features underlying the skull and possibly embedded within the brain material.

In some example embodiments, the brain model is suitable for simulating a medical procedure involving a brain tumor that has been selected for resection. In such an example embodiment, the brain model is comprised of a brain material having a simulated brain tumor provided therein. This brain material simulates, mimics, or imitates at least a portion of the brain at which the medical procedure is directed or focused.

The simulation of the above described medical procedure is achieved through simulation of both the surgical procedure and the associated imaging steps that are performed prior to surgery (pre-operative imaging) and during surgery (intra-operative imaging). Pre-operative imaging simulation is used to train surgical teams on co-registration of images obtained through more than one imaging methodology such as magnetic resonance (MR), computed tomography (CT) and positron emission tomography (PET). Appropriate co-registration geometrically aligns images from different modalities and, hence, aids in surgical planning step where affected regions in the human body are identified and suitable route to access the affected region is selected. Another use of pre-operative imaging is to train the surgical team and radiologists on optimizing the imaging parameters so that clinically relevant images are acquired prior to the surgical procedure. For example, pre-operative MR images need to be acquired in a specific manner to ensure that the acquired data can be used to generate tractography information, such as Diffusion Tensor Imaging (DTI), which shows the location and direction of the brain tracks which are not visually observable by the surgeon. Intra-operative imaging is used to guide the surgeon through accurate surgical intervention while avoiding damaging the brain tracks if possible. Surgical intervention includes accessing a previously identified affected region in the human body and subsequent resection of affected tissue.

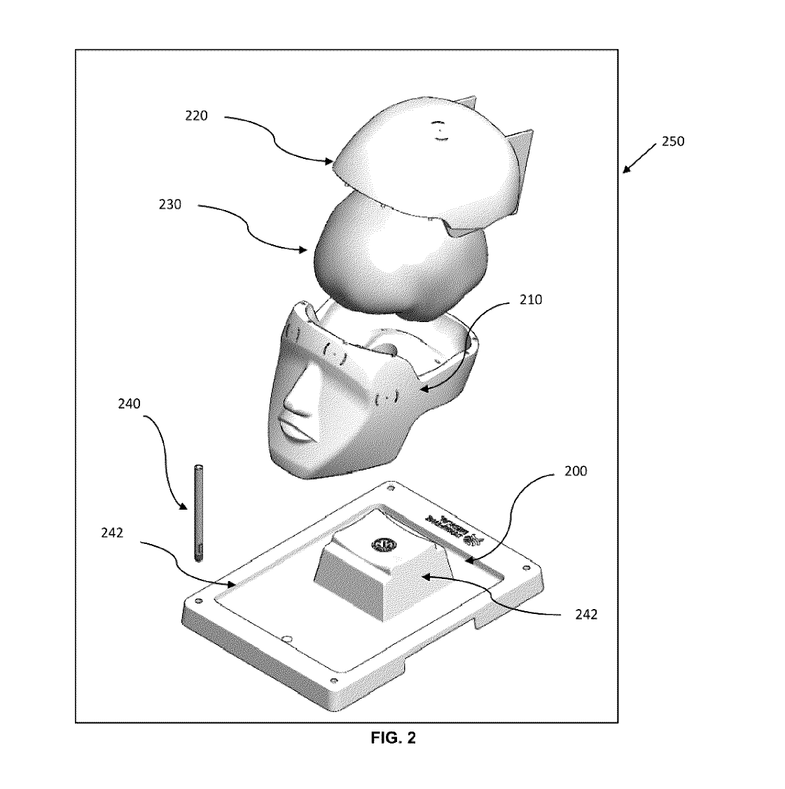

Referring to FIGS. 2-5, an exploded view of an example model or phantom shown generally at 250 is provided that is suitable for use in training or simulation of a medical procedure which is invasive of a mammalian head. The training model 250 may be adapted or designed to simulate any mammalian head or a portion thereof. It is to be understood that the person to be trained may be selected from a wide variety of roles, including, but not limited to, a medical doctor, resident, student, researcher, equipment technician, or other practitioner, professionals, or personnel. In other embodiments, the models provided herein may be employed in simulations involving the use of automated equipment, such as robotic surgical and/or diagnostic systems.

Referring now to FIG. 2, an exploded view of an example implementation of training model (250) is shown that includes a base component and a training component. The base component is comprised of a tray component (200) and a head component. The head component is comprised of a bowl component (210) and a skull component (220). The training component may be comprised of a brain (230) with the following layers: dura, CSF (cerebro spinal fluid), vessels, white matter, grey matter, fiber bundles or tracks, target tumors, or other anomalous structures. The training component may also include the aforementioned skull component (220) when crafted in a skull mimicking material. Optionally, the training model (250) may be also comprised of a covering skin layer (not shown). Further, the base component may include a holder (240) provided on the tray (200) to facilitate easy mounting of fiducials or reference points for navigation.

Referring to FIG. 2, the tray component (200) forming part of the base component defines a training receptacle which includes a pedestal section (242) which is sized and configured for receipt of the bowl component (210) therein. Thus the training component is sized, configured or otherwise adapted to be compatible with, or complementary to the base component, and particularly the training component receptacle, such that the base component and the training component may be assembled to provide the assembled training model (250).

The base component may have any size, shape and configuration capable of maintaining the training component, mounted within the training component receptacle, in a position suitable for performing the medical procedure to be trained. This base component comprises features that enable registration, such as fiducials, touchpoint locations, and facial contours for 3D surface scanning, MR, CT, optical coherence tomography (OCT), ultrasound (US), PET, optical registration or facial registration. Furthermore, the base component is adapted or configured to maintain the training component in a relatively stable or fixed position throughout the performance of the medical procedure to be simulated during the training procedure. The base component provides both mechanical support during the training procedure and aids in the proper orientation of the training components to mimic actual positioning of a patient's head during the surgical procedure.

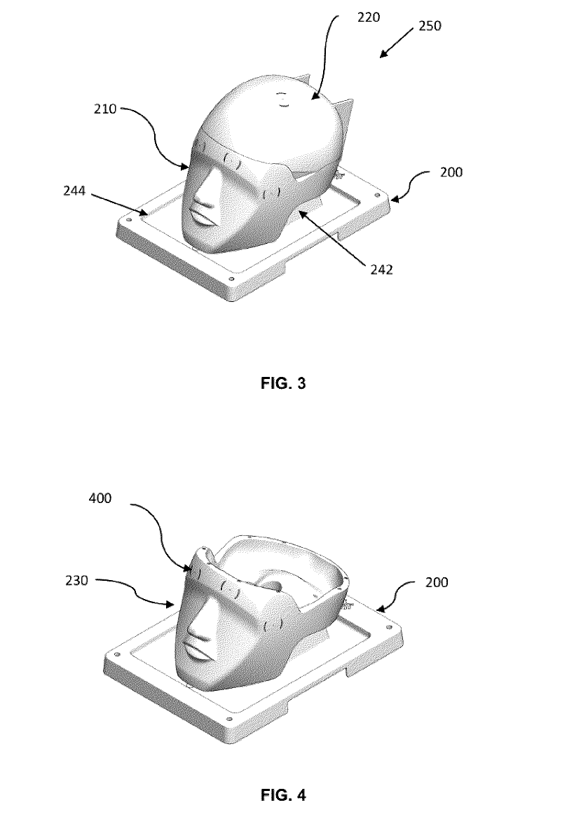

Referring to FIGS. 2 and 3, as noted above, the base component may be comprised of a head component (210) and a tray component (200). The tray component (200) is sized, configured or otherwise adapted to be compatible with, or complementary to the head component (210). The tray component (200) and pedestal (242) are adapted or configured to maintain the head component (210) in a relatively stable or fixed position throughout the performance of the imaging or medical procedure to be simulated. This may be accomplished with the use of a mechanical feature such as a snap mechanism that exists to affix the head component (210) to the tray component (200). The tray component (200) may contain a trough (244) to catch liquids, and insertion points to affix hardware to aid with image registration and/or the medical procedure to be trained.

The head component (210) is sized, configured or otherwise adapted to be compatible with, or complementary to the tray component (200) and the training component (230). The head (bowl) component (210) is adapted or configured to maintain the training component (230) (located under skull component (220)) in a relatively stable or fixed position throughout the performance of the medical procedure to be simulated. This head component (210) is adapted or configured to enable anatomically correct surgical positioning. This may include affixing the head component (210) with a surgical skull clamp or headrest, for example a Mayfield skull clamp. This head component (210) is also adapted or configured to enable anatomically correct imaging positioning for any contemplated imaging modality including, but not limited to, MR, CT, OCT, US, PET, optical registration or facial registration. For example the head component (210) may be positioned in a supine position within an magnetic resonance imaging (MRI) apparatus to enable anatomically accurate coronal image acquisition.

In some embodiments, the head component (210) is shaped or configured to simulate a complete or full skull. In other words, the training component comprises bowl section (210) and skull section (220), while the bowl section (210) comprises a further portion of a complete skull and head. In some embodiments, as shown in FIG. 2, the head component i.e., bowl section (210) and skull section (220), and training component (230) together provide a complete simulated skull or together provide a simulated head including skull (220) and brain (230). The simulated head provided by the training model (250) enhances the reality of the overall simulation training experience.

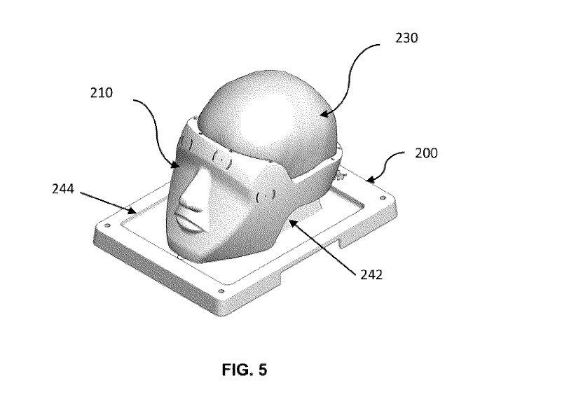

In addition, the base and training components of the training model (250), and particularly the head component, may also include one or more external anatomic landmarks or fiducial locations (400), as shown in FIG. 4, such as those likely to be relied upon by the medical practitioner for image registration for example, touchpoints, the orbital surface, nasal bone, middle nasal concha, inferior nasal concha, occipital bone, nape, and nasal passage. These features will aid in registering the training component with the preoperative images, such as MR, CT, OCT, US, PET, so that the surgical tools can be navigated appropriately.

In this regard, navigation to establish the location of the hole or passage through the skull of the patient during the craniotomy procedure is often critical for the success of the medical procedure. Accordingly, external anatomic landmarks and/or touchpoints are provided by the simulated head in order to provide training on the correct registration of the training model with the acquired images. These anatomic landmarks and/or touchpoints may be utilized for attaching registration hardware, for example a facial registration mask or fiducial landmark. Thus, the training model (250), and particularly the simulated head, including the brain (230), bowl (210) and skull cap (220), are sized, configured and shaped to approximate and closely resemble the size, configuration and shape of the head of a patient on which the medical procedure is to be performed. In other words, the head component may be both life-like' and ‘life-sized’.

The base component may be comprised of any composition or material suitable for providing the training component receptacle, and may be suitable for being cast, molded or otherwise configured to provide or support the simulated head when assembled with the training component. For instance, the base component may be comprised of any suitable casting compound, casting composition or plaster. The base component may be comprised of a material that is rigid, non-reflective, non-ferrous, non-porous, cleanable, and lightweight, for example a urethane or acrylonitrile butadiene styrene (ABS). In addition, the bowl (210) and skull (220) components of the base component may be comprised of a material that is visible by the imaging procedure of interest to enable registration. The material for the bowl (210) and skull cap (220) components of the base may therefore be selected to be visible by MR, CT, and/or PET.

As shown in FIG. 5, the training component (230) and the base component (210) are complementary or compatible such that when the training component (230) is mounted on the pedestal (242) in the training component receptacle (244) in tray (200), together they provide the training model (250) with the skull cap (220) removed. Furthermore, the configuration and dimensions of the training component (230) and the bowl component (210) are complimentary or compatible such that the training component (230) may be received and fixedly or releasably mounted in the bowl component (210).

In some embodiments, in order to permit the replacement or substitution of the training component (230), the training component is detachably or releasably mounted in the bowl component (210). Any detachable or releasable fastener or fastening mechanism may be used which is capable of securing the training component (230) in the receptacle, while also permitting the training component (230) to be readily detached, released or removed as desired or required. In one embodiment, the training component (230) is releasably or detachably mounted within the bowl component (210), specifically the training component is held within the bowl component (210) to emulate the mechanical fixation of the brain component (230) in the skull (220).

Thus, in the present example embodiment, the training component (230) may be removed from the bowl component (210) and replaced with an alternate, replacement or substitute training component as desired or required by the user of the training model (250). For instance, a replacement training component (230) may be required where the previous training component (230) is damaged or modified during the training of the procedure. An alternate training component (230) may be adapted or designed for use in the training of the performance of a specific medical procedure or condition of the patient, allowing for the reuse of the bowl component (210).

Alternatively, as indicated, the training model (250) may not include the bowl component (210). In this instance, the other components comprising the training model (250), such as the training component (230) in isolation, may be supported directly by a supporting structure or a support mechanism (not shown) that does not look like a mammalian head. Specifically, the supporting structure may securely maintain the training component (230), without the other components of the training model, in the desired orientation. In such an embodiment, the training component (230) may be releasably attached or fastened with the supporting structure such that the training component (230) may be removed from the supporting structure and replaced with an alternate, replacement or substitute training component (230) as desired or required by the user of the training model (250).

Recently it has been demonstrated that spectroscopy can provide a valuable tool for distinguishing between tumor and healthy tissue (see for example: “Quantitative optical spectroscopy for tissue diagnosis,” Annual Review of Physical Chemistry, Vol. 47: 555-606 and “Identification of primary tumors of brain metastases by SIMCA classification of IR spectroscopic images.” Christoph Krafft et.al, Biochimica et Biophysica Acta BBA)—Biomembranes, Vol 1758, Issue 7, Jul. 2006). However, neurosurgeons are not sufficiently trained on the use and interpretation of spectroscopy data in context of tissue differentiation and/or tissue identification. Hence, a training tool that will help neurosurgeons learn spectroscopy-based classification of brain tissue specifically in the context of tumor resection will be valuable as a contextual training tool.

The present disclosure is directed to an anatomical phantom of an anatomical part having embedded therein components containing spectroscopically different constituents used to demark various different volumes of the phantom, with the different spectroscopically active volumes representing for example different constituents of the anatomical part and/or healthy tissue versus tumorous tissue. Initially, a mold of the anatomical part is produced. In the case that the anatomical phantoms are for general training purposes, and not patient specific, they may be generic and the size, shape and constituent components of the anatomical part may be obtained from anatomical atlases. If on the other hand they are for patient specific training, the mold of the anatomical part may be obtained by preoperative imaging of the patient's anatomical part, such as but not limited to x-ray, positron emission spectroscopy (PET), magnetic resonance imaging (MRI), optical coherence tomography (OCT), ultrasound (US), or simply laser surface scanning of the anatomical part, to mention a few.

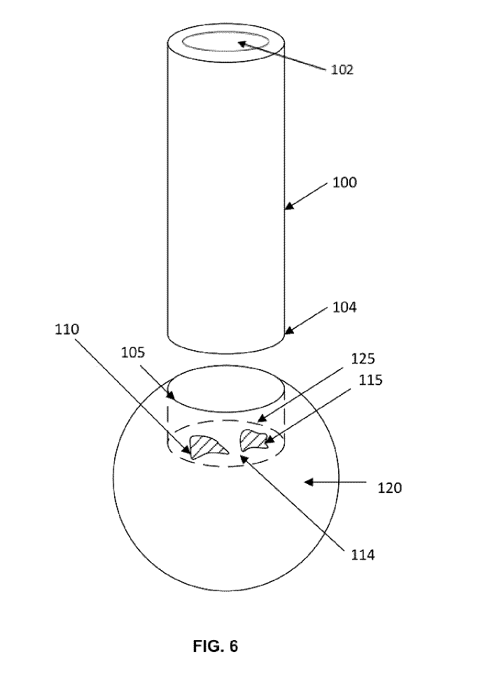

Referring to FIG. 6, a surgical phantom training tool disclosed herein is shown generally at (250) and is comprised of cylindrical tube or port tube (100) (also shown in FIG. 1) having a passageway (102) extending through the port (100) that emulates a surgical port (commonly used in minimally invasive brain tumor resection) and a container (120) at the distal end (104) of the port (100) that contains tissue mimicking material (114) embedded with specific regions (115 and 110) that have distinctly different spectral characteristics. A reference marker (not shown) may be optionally attached to the tube (100) to facilitate the use of a navigation system. FIG. 6 illustrates the port (100) disassembled from the container (120) that encapsulates the brain simulating material (114) for the sake of clarity. The system is comprised of the tube (100) attached to the container 120). The port (100) may be optionally embedded in the container (120) (shown as 105) in FIG. 6) to create a flat surface (125) at the bottom of the port (100); but, this flat surface may be also created without embedding the port (100) in the container (120).

Specific regions (for example regions (110) and (115) in FIG. 6) within the brain simulating material (114) may be manufactured to have distinct spectral characteristics that is distinguishably different from rest of the region by impregnating the tissue mimicking material at known regions with spectroscopically active materials that have known and distinct detectable spectral characteristics (absorption, scattering, fluorescence, phosphorescence, Raman scattering, linear birefringence, circular birefringence, linear dichroism, circular dichroism, etc.). This can be achieved by using a robotic manufacturing system that can be programmed to consistently inject controlled volumes of the spectroscopically active materials at specific spatial locations within the tissue mimicking material (114) during production of the phantom.

The anatomical phantom may be produced with a specified volume within the tissue mimic material having the spectroscopically active material embedded therein so as to specroscopically distinguish it from the rest of the mimic material which may be spectroscopically active in any way, so that once the probe crosses from the inactive portion to the active portion the student/trainee is alerted to this by the detection of a spectroscopically signal. In other embodiments multiple spectroscopically active volumes spaced from each other or contiguous with one or more other different spectroscopically active volumes provides multiple spectroscopic signals as the probe crosses the boundaries from one region to the next.

One example of tissue mimicking material (114) may be the material used in U.S. Provisional Applications 61/900,122 filed 5 Nov. 2013 and 61/845,256 filed Jul. 11, 2013 and International Patent Application CA/2014/050659 filed on Jul. 10, 2014, which are incorporated herein by reference in their entirety. These materials, being based on thermally cycled hydrogels, can be prepared by loading the optical active materials into the hydrogel liquid precursor materials used to fabricate the various sections of the phantom. The tissue mimicking material (114) and the injected spectroscopically active materials, with known spectral characteristics, can be selected such that natural diffusion of injected spectroscopically active materials in the tissue mimicking material is minimized. This minimizes movement of the injected spectroscopically active materials away from the pre-determined location.

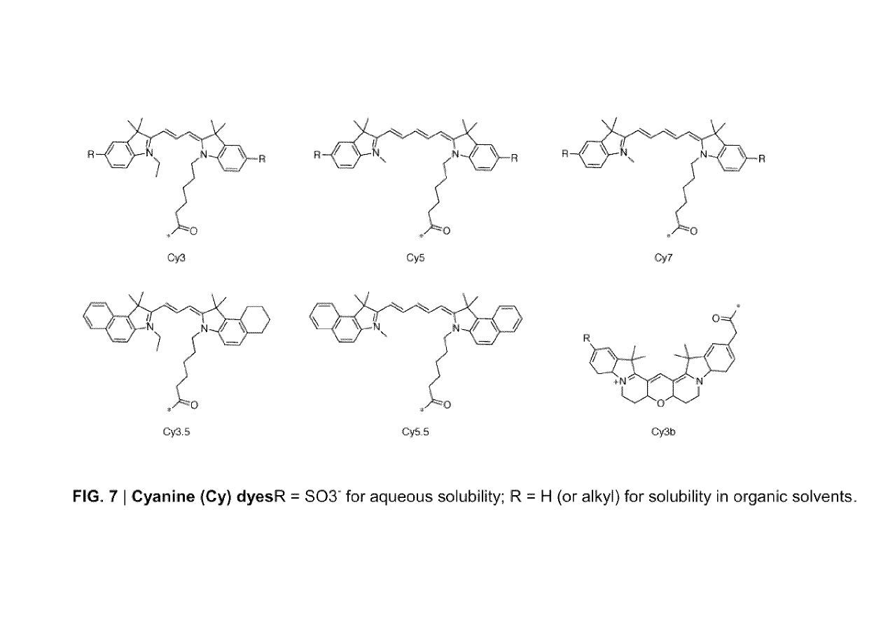

One non-limiting class of materials that may be used having known spectroscopic signatures are fluorophores. Examples of fluorophore materials that may be used for the purpose of presenting a region with distinct spectral characteristics may be Cy5 (cyanine 5) dye that is commonly used in molecular biology as a fluorophore. Another chemical that is easy to differentiate using a spectrometer is the Cy5.5 dye. FIG. 7 shows the structures of the cyanine dyes and Table 1 shows their absorption/emission characteristics and it will be appreciated that any of these may be used. As can be seen from Table 1, both these Cy5 and Cy5.5 dyes have distinct spectral characteristics when illuminated by coherent light sources with specific wavelengths as indicated. In the case of Cy5 and Cy5.5, the illumination light source may be a laser within a wavelength in the vicinity of 649 nm, while Cy5.5 the illumination light source needs to be able to excite at around 675 nm.

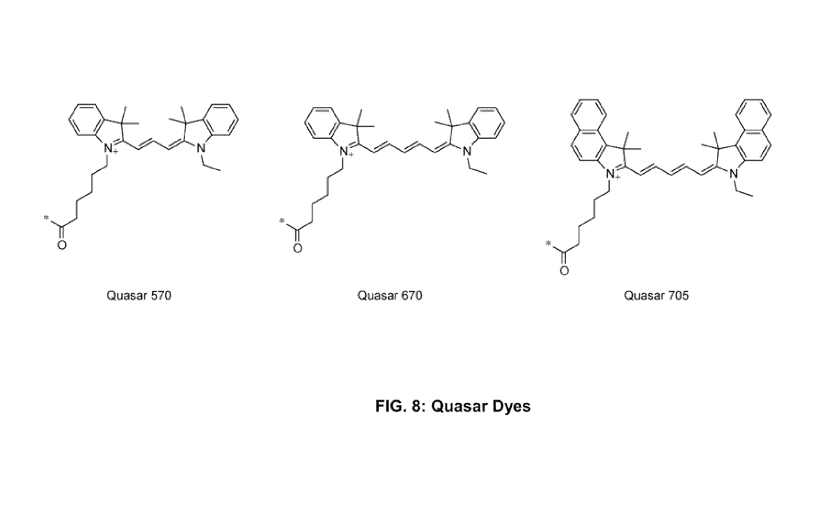

Another class of dyes very similar to the cyanine dyes are the Quasar® dyes, which are manufactured and sold by Biosearch Technologue. These dyes may be used as replacements for the Cy dyes and these Quasar dyes are chemically very similar to the Cy dyes (shown in FIG. 8) so that the properties of the Quasar dyes are essentially identical to those of the Cy dyes. Table 1 also shows physical properties of the Quasar dyes are compared with those of the Cy dyes. The dyes may be attached to gold or silver nanoparticles and Surface Enhanced Raman Spectroscopy (SERS) may be used to detect the presence of the particles, with different sections of the phantom being embedded with nanoparticles functionalized with different dye molecules having their own unique Raman signature.

Other materials with known spectral composition include, but are not limited to, acetylsalicylic acid (or commonly known as aspirin) and acetaminophen both of which have very well characterized Raman spectra.

In addition to chemical species as the spectroscopically active material, other spectroscopically active materials may be used as well, including but not limited to nanoparticles such as semiconductor nanoparticles with bandgaps which, depending on the type of semiconductor material and the size of the nanoparticle may be in the infrared, visible and ultraviolet portions of the spectrum such that absorption and excitation of electrons into the conduction band with light of energy greater than the bandgap will result in light being emitted at the bandgap energy when recombination occurs.

As noted above, these different spectroscopically active materials may be injected during production of the phantom under controlled conditions into different parts of the phantom tissue mimicking material (114) to represent different anatomical parts or diseased sections of the phantom.

When hydrogel materials are used to produce the training model (230), shown and described herein as a brain phantom, the hydrogel precursor can be functionalized via the —OH group to contain spectroscopically active side-groups that are covalently bonded. In this embodiment the brain phantom (230) may be produced with different sections of the hydrogel material having different spectroscopically distinct side-groups incorporated therein to represent different anatomical parts of the phantom and/or diseased sections of the phantom.

There are several different types of embodiments of the training phantoms that may be produced, depending on the type of surgical training being envisioned. The following different examples will make reference to a human brain phantom but it will be understood that the present disclosure applies to any anatomical part of any animal or human. A first embodiment of a basic anatomical training phantom may be comprised of a phantom with various anatomically distinct regions of the phantom being demarked only using the spectroscopically active materials. In other words the hydrogel (when this is used as the fundamental building block of the phantom) may be uniform with different sections corresponding to anatomically different regions being demarked by the presence of different materials with different spectral characteristics.

In a second embodiment a phantom having a simulated tumor embedded therein may include a uniform and homogenous brain material (such as hydrogel) such that there is no differentiation between various anatomical parts reflected in the phantom. The simulated tumor embedded therein and the rest of the phantom material would then each have distinctly different spectroscopically active materials mixed with the material of each section to provide differentiation. In the simplest embodiment the tumor and the rest of the anatomical phantom may be made of the same material. Such as phantom is useful when the goal of the phantom is simply to use spectroscopy alone to differentiate between the tumor and the rest of the anatomical part, and no tactile functionality is required.

The first and second embodiments disclosed above are useful for training for differentiating between different tissues based only on the spectroscopic differences, not requiring tactile differences as part of the training. Typically the spectroscopically active materials, unless illuminated will not render the boundaries between the volumes with different spectroscopically active materials visible to the naked eye. Thus the operator must rely on visually detecting the difference in emission/scattering signatures to differentiate between the different tissue types. Referring to FIG. 6, in this embodiment a simulated surgical tool may simply be a handheld laser source coupled with a detector which are held by the operator in conduit (102) used by the operator to illuminate the phantom tissue (114) in phantom (120) at the bottom of port (100) and to scan across the tissue. In this embodiment the detector and the laser light source may be aligned coaxially and held rigid with respect to each other. The laser source and the different spectroscopically active materials with different spectroscopic signatures may be selected so that both produce signals when illuminated by the single laser source but each emits at different wavelengths which are detected by the detector. The different spectroscopic signals detected by the detector, for example when scanning from phantom component (110) to phantom component (115), are then displayed on a screen or print out showing the different emission wavelengths visible to the student so they can readily discern the different “tissue types” in the phantom. An alternative to the detector being mounted with the laser illuminator, the detector(s) could be mounted on the inside of port (100) or one or more detectors may be spaced from the access into conduit (102) at the distal end of the port (100) and positioned and oriented to pick up light emission from anywhere inside phantom (120) from constituents (110) and (115).

In a third embodiment a phantom may be produced to include various anatomically distinct regions of the phantom being made of materials of different densities to emulate actual physiological components of the anatomical part as well as one or more simulated tumors made of materials selected to give biomechanical properties similar to actual tumors. All the various constituents are produced to include materials of different spectral characteristics with an a priori correlation between the particular anatomical constituent and the spectroscopically material representing a given anatomical constituent. In this embodiment, the training program can involve the operator using both optical and tactile properties to differentiate between the various constituent anatomical parts and one or more tumor mimics embedded therein.

This third embodiment is useful for training the student to differentiate different tissue types making up the phantom based on both optical interpretation of the spectroscopic signals as well as on the basis of tactile feedback. In this embodiment, the student may have a surgical instrument that includes a scalpel (or any other tool normally employed in surgical procedures) mounted together with a laser light source with the tool and laser rigidly mounted with respect to each other. The surgical tool and the laser source may be mounted with respect to each other so that tip of the surgical tool and the laser beam at the location of the tool tip are coincident so that in the case of a scalpel and resection of the tumor simulation, the laser beam illuminates the tissue phantom at the point of contact with the scalpel.

Since a robotic system or similar spatially accurate manufacturing system may be used to impregnate the tissue mimicking material with controlled volumes of differing materials having known different spectral characteristics, the exact location of regions in the tissue mimicking material that have the known spectral characteristics can be pre-determined at the time of manufacturing of the training system. The operator is then tasked with using a spectrometer and the stimulation light source (identified above as a laser but other light sources may be used in addition to coherent light sources) to identify regions at the distal end of the port with different spectral characteristics. The exact location of such regions may be indicated by the operator using a pointer tool that is tracked by a navigation system. Alternatively, the spectrometer probe may have navigation markers attached to it so that the probe's spatial location, specifically the location on the tissue surface (125) that is sampled by the spectrometer probe may be tracked using a navigation system. The resulting positions identified by the operator may be then compared to the pre-determined locations of these samples used during the manufacture of the training system. The identity and location can thus be used to arrive at a training score to indicate the accuracy of spatial and chemical identification.

The above described simulation system may be embedded in the brain simulator without the presence of port (100). The tumor material may be impregnated with material that have distinct spectral characteristics relative to remainder of the tissue mimicking material used to construct the white-matter portion of the brain simulator. However, similar manufacturing and scoring methods may be repeated in this configuration so that the operator performs an entire tumor resection workflow along with the use of spectroscopy tools for accurate tissue differentiation.

The effectiveness of the training tool in helping the surgeon familiarize themselves with tissue differentiation can be assessed based on one or more of the following parameters:

Spatial proximity: compare the spatial position (or region) identified by the operator to the spatial location established during the manufacturing process. If multiple regions need to be identified, the average deviation of identified location relative to actual location may be used for the purpose of establishing spatial accuracy of the operator.
Correctness of tissue differentiation: the operator can also identify the tissue type and this result can be compared with ground truth which is established during manufacturing process. Tissue differentiation may be assessed using tissue identified by the operator relative to the actual tissue type at identified regions. The operator may be given a priori information of potential location of different tissue types or information from (a), above, may be combined with the tissue type score.

A weighted score can be established using above parameters and the result can be presented as separate scores or a single combined score.

While the Applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

Except to the extent necessary or inherent in the processes themselves, no particular order to steps or stages of methods or processes described in this disclosure is intended or implied. In many cases the order of process steps may be varied without changing the purpose, effect, or import of the methods described.

TABLE 1
Common fluorescent dyes; their associated wavelengths of
absorption (excitation) and emission, and colors

| | λₘₐₓ/nm | λₘₐₓ/nm | | | | |
|---|---|---|---|---|---|---|
| Name | (absorption) | (emission) | Colour | E at λₘₐₓ | φ | τ/ns |
| Cy3 | 550 | 570 | Dark pink | 136 000 | 0.15 | — |
| Cy3.5 | 591 | 604 | — | 116 000 | 0.15 | <0.3 |
| Cy3b | 558 | 572 | — | 130 000 | 0.67 | 2.8 |
| Cy5 | 649 | 670 | Blue | 250 000 | 0.3 | — |
| Cy5.5 | 675 | 695 | Blue | 209,000 | 0.3 | — |
| Quasar | 548 | 566 | Dark pink | 115 000 | — | — |
| 570 | | | | | | |
| Quasar | 647 | 670 | Blue | 187 000 | — | — |
| 670 | | | | | | |
| Quasar | 690 | 705 | Blue | 206 000 | — | — |
| 705 | | | | | | |

E: extinction coefficient;
φ = quantum yield;
τ = fluorescence lifetime. Data from various sources including www.biosearchtech.com and www.glenresearch.com. Cy3b data from Cooper et al., Journal of Fluorescence 14 (2), 145-150, 2004.

1. A training phantom, comprising:
a tissue mimic material formed into a volume of selected shape and size, the tissue mimic material being selected to mimic any one or combination of biomechanical and imaging properties of a given anatomical part; and
at least one sub-volume of the volume of the tissue mimic material having located therein a spectroscopically active component which, when optically excited, responsively emits a distinct spectroscopic signature indicative of the sub-volume having a composition different to the rest of the volume.

2. The phantom according to claim 1 wherein the at least one sub-volume of the tissue mimic material having said spectroscopically active component located therein is designated as a diseased tissue, and the tissue mimic material in the rest of the volume is designated as healthy tissue.

3. The phantom according to claim 1 wherein the at least one sub-volume of the volume is two or more sub-volumes, and wherein each sub-volume of the tissue mimic material includes a spectroscopically active component having distinct spectroscopic signatures different from the spectroscopically active components in all other sub-volumes.

4. The phantom according to claim 3 wherein the two or more sub-volumes are spaced apart from each other.

5. The phantom according to claim 3 wherein at least some of the two or more sub-volumes are contiguous in touching relationship to each other.

6. The phantom according to claim 3 wherein the anatomical part being emulated includes a given number of constituent tissue types different from each other, and wherein said volume includes a same given number of sub-volumes each provided with a spectroscopic material distinct from the spectroscopically distinct materials in the other sub-volumes with each being representative of a different tissue type.

7. The phantom according to claim 1 wherein said distinct spectroscopic signature includes absorption, scattering, fluorescence, phosphorescence, Raman scattering, linear birefringence, circular birefringence, linear dichroism, and circular dichroism.

8. The phantom according to claim 1 wherein said spectroscopically active components include any one or combination of fluorophores and nanoparticles.

9. The phantom according to claim 1 wherein the selected shape and size corresponds to a size and shape of a human brain.

10. The phantom according to claim 9 wherein the size and shape of a human brain corresponds to a size and shape of a patient's brain, and wherein the size and shape are determined from imaging data used to image the patient's brain.

11. The phantom according to claim 10 wherein the at least one sub-volume of the tissue mimic material having said spectroscopically active component located therein is designated as a diseased tissue, and the tissue mimic material in the rest of the volume is designated as healthy tissue, and wherein the diseased tissue is identified from the imaging data used to image the patient's brain.

12. The phantom according to claim 11, wherein the sub-volume designated as diseased tissue is located in the brain phantom in a same location as the diseased tissue is located in the patient's brain.

13. The phantom according to claim 12, wherein the diseased tissue represents a tumor, and wherein a tumor phantom incorporating the spectroscopically active component is produced from a material that exhibit biomechanical properties similar to that of the actual tumor located in the patient's brain.

14. A method of producing a training phantom, comprising the steps of:
providing a mold of size and shape and volume of a given anatomical part for which the training phantom is being produced;
providing a volume of liquid precursor of a tissue mimic material, the volume being substantially the same as the volume of the given anatomical part, and mixing at least one sub-volume of said volume of liquid precursor with a spectroscopically active component which, when optically excited, responsively emits a distinct spectroscopic signature indicative of the sub-volume having a composition different to the rest of the volume;
curing the at least one sub-volume of liquid precursor containing the spectroscopically active component; and
supporting the at least one sub-volume in a given location in the mold, and filling the mold with a remainder of the volume and curing the remainder of the volume to produce a phantom having at least one sub-volume having a spectroscopically active component mixed therein.

15. The method according to claim 14 wherein the at least one sub-volume of the tissue mimic material having said spectroscopically active component located therein is designated as a diseased tissue, and the tissue mimic material in the rest of the volume is designated as healthy tissue.

16. The method according to claim 14 wherein the at least one sub-volume of the volume is two or more sub-volumes, and wherein each sub-volume of the tissue mimic material includes a spectroscopically active component having distinct spectroscopic signatures different from the spectroscopically active components in all other sub-volumes.

17. The method according to claim 14 wherein said distinct spectroscopic signature includes absorption, scattering, fluorescence, phosphorescence, Raman scattering, linear birefringence, circular birefringence, linear dichroism, and circular dichroism.

18. The method according to claim 14 wherein said spectroscopically active components include any one or combination of fluorophores and nanoparticles.

19. (canceled)

20. The method according to claim 14 wherein the size and shape corresponds to a size and shape of a patient's brain, and wherein the size and shape are determined from imaging data used to image the patient's brain.

21. The method according to claim 20 wherein the at least one sub-volume of the tissue mimic material having said spectroscopically active component located therein is designated as a diseased tissue, and the tissue mimic material in the rest of the volume is designated as healthy tissue, and wherein the diseased tissue is identified from the imaging data used to image the patient's brain.

22-23. (canceled)
